(19) United States
(12) Patent Application Publication
(10) Pub. No.: US 2005/0203980 A1
(43) Pub. Date: Sep. 15, 2005

(54) Computing transcendental functions using single instruction multiple data (SIMD) operations

(76) Inventors: John R. Harrison, Beaverton, OR (US); Ping Tak Peter Tang, Hayward, CA (US)

Correspondence Address: TROP PRUNER & HU, PC, 8554 KATY FREEWAY, SUITE 100, HOUSTON, TX, 77024, US

(21) Appl. No.: 10/798,757

(22) Filed: Mar. 11, 2004

(51) Int. Cl. G06F 1/02

(52) U.S. Cl. 708/290

(57) ABSTRACT

In one embodiment, the present invention includes a method for reducing an input argument x of a function to a range reduced value r according to a first reduction sequence, approximating a polynomial for a corresponding function of r having a dominant portion f(A)+σr, and obtaining a result for the function using the polynomial.

### BACKGROUND

The present invention relates to computation of transcendental functions. The fast and accurate evaluation of transcendental functions such as exponentials, logarithms, and trigonometric functions and their inverses, is highly desirable in many fields. Software implementations typically use lookup tables to approximate one or more intermediate values in the computation for faster evaluation.

For example, a standard approach to implementation of floating-point mathematical functions is to use a table of precomputed values and interpolate between them using a simple reconstruction formula based on the table entry and a smaller “reduced” argument. For example, sine (sin)(x) for a floating-point number x may be calculated using a precomputed table of values sin(A) and cosine (cos)(A) for various “breakpoints” using the reconstruction formula:
sin(x)=sin(A)+sin(A)[cos(r)−1]+cos(A)sin(r) [1]
where r=x−A. Typically, the breakpoints are evenly spaced at some distance d (e.g., π/32 for sin), so A=nd for n└ [symbol] . With breakpoints a distance d apart, a straightforward remainder operation can find a reduced argument with |r|≦d/2. If this bound is reasonably small, e.g., on the order of 2⁻⁵, sin(r) and cos(r)−1 may be approximated by polynomials such that convergence is rapid and not many terms of the polynomial are required, and the polynomial size is small compared with the size of the overall result.

The latter property means that rounding errors in the polynomial are correspondingly small compared with the overall result, which is dominated by a single table entry, sin(A) in the above example. Thus, the computation can be organized as a final addition of a table entry and a relatively small term, making the overall error close to the 0.5 units in the last place (ulp) ideal.

In many applications of floating-point transcendental functions, it is common for both sin(x) and cos(x) to be needed at about the same time. While it is desirable to provide a combined sincos routine that can calculate both with efficiency over separate computations, the table-driven technique described above causes significant problems. Because the property that the table entry dominates tends to break down when A is small (e.g., when the breakpoint is the smallest nonzero value ±d and r≈±d/2), a separate path instruction for smaller inputs that use the first few table entries is executed. This separate path is typically a pure polynomial, and is often quite long since it is evaluated for x significantly larger than d/2.

A branch to choose between two paths is a significant disadvantage, as it is difficult to achieve software pipelining by overlapping multiple calls, and may also incur a significant branch misprediction penalty. More seriously, for a combined single instruction multiple data (SIMD) implementation of sin and cos, the difficulty is exacerbated as the special branch is exercised for different kinds of values in the two cases. For sin, it occurs when the input is close to an even multiple of π/2, while for cos it occurs when the input is close to an odd multiple of π/2. Thus a need exists for a branchless manner of calculating transcendental functions, particularly in an SIMD implementation.

### BRIEF DESCRIPTION OF THE DRAWINGS

FIG. 1 is flow diagram of a method in accordance with one embodiment of the present invention.

FIG. 2 is a flow diagram of a method of determining sin(x) and cos(x) in accordance with an embodiment of the present invention.

FIG. 3 is a block diagram of a computer system with which embodiments of the invention may be used.

### DETAILED DESCRIPTION

Floating-point transcendental functions, such as sin(x) and cos(x), may need to be calculated for the same x at about the same time. In various embodiments, both sine and cosine may be computed together with almost the same efficiency as a single computation of either.

In certain implementations, SIMD floating-point operations may be used. In certain such implementations, streaming SIMD Extension 2 (SSE2) instructions, which include operations on packed data formats and provide increased SIMD computational performance, may be used. Such instructions may be part of an Intel® PENTIUM 4® processor instruction set or an instruction set of another such processor.

In such manner, sin and cos may each be computed in half of a parallel operation using the same instruction stream. In order to maintain this parallelism, an algorithm in accordance with an embodiment of the present invention may use “branch-free” techniques to avoid special code for small arguments, which would otherwise create asymmetry between the sin and cos instruction streams. As a result, branch mispredictions may be reduced.

In various embodiments of the present invention, transcendental functions may be computed using three basic steps: reduction, approximation, and reconstruction. A reduction may be used to transform an input argument x according to a predetermined equation to limit it to a predetermined range. Next, an approximation is performed by computing an approximating polynomial for the reduced argument of the reduction. Finally, reconstruction obtains a final result for the original function using the result of the approximating polynomial and a polynomial remainder.

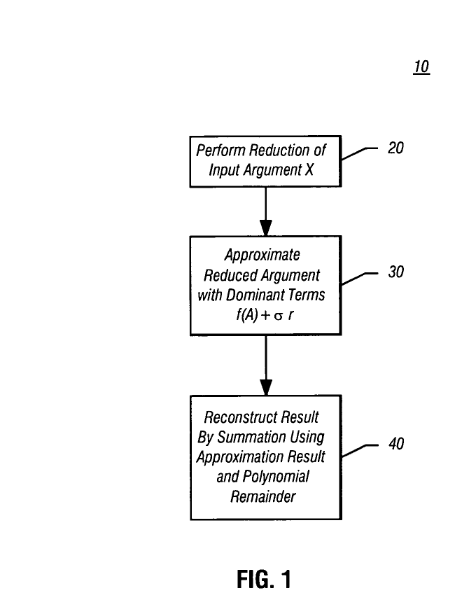

Referring now to FIG. 1, shown is flow diagram of a method in accordance with one embodiment of the present invention. As shown in FIG. 1, method 10 begins by reducing a given function's input argument x (block 20). In one embodiment, the reduction may take the form of r=x−A. Next, the reduced argument may be approximated with a polynomial having dominant terms f(A)+σr (block 30). In various embodiments, these two terms always dominate the final result, regardless of size of the input argument. Finally, reconstruction may be performed to obtain a final result by summing the approximation result and a polynomial remainder (block 40).

Embodiments of the present invention may be applicable to mathematical functions f(x), the magnitude of whose slope near x=0 is close to a power of 2. Such functions include, for example, sin(x) and tangent (tan)(x), which both have a slope close to 1 near x=0, and cos(x) by using cos(x)=sin(x+π/2).

In such embodiments, the reduction may be performed to obtain a range reduced argument for computing an approximation. In one embodiment, the approximation may be represented as:

$$f ( x ) = ( f ( A ) + σ r ) + ( {f}^{′} ( A ) - σ ) \cdot r + \frac{{f}^{″} ( A )}{2} {r}^{2} + ⋯ \qquad [ 2 ]$$

where |σ|=±2^{α} for some α. While α may vary, in certain embodiments it may be between about −3 and 1, and in particular embodiments may be between about ⅛ and 1. In the above Equation 2, f(A) and f′(A) may be obtained from suitable breakpoints in a lookup table. In certain embodiments, α may change over the range of x, and may be tabulated in the form of a lookup table similarly to f(A).

As an example, for the sin function, a core approximation may take the form of:
sin(x)=(sin(A)+σr)+(cos(A)−σ)•r+sin(A)[cos(r)−1]+cos(A)[sin(r)−r] [3]
where σ is cos(A) rounded to 1 bit of precision. Both sin(A) and cos(A) may be obtained by finding a suitable breakpoint stored in a lookup table. Where A is fairly small, σ=±1. In other embodiments, σ may be equal to a closest power of two.

The reconstruction of this approximation has the property that the first two terms f(A)+σr (in the above example, sin(A)+σr) always constitute the dominant part of the final answer, even for a small x. At the low end of the polynomial, |(f′(A)−σ)•r| is much less than |σr|, while at the high end, f(A) is large enough such that it dominates the reconstruction.

Since multiplication by a power of 2 is exact, ±σr may always be computed exactly by a simple floating-point multiplication. The sum f(A)+σr may then be computed in two parts by an exact summation technique. Because usually either f(A)=0 or |σr|≦|f(A)|, an exact sum may be obtained by three successive addition/subtraction operations:
Hi=f(A)+σr [4]
Med=Hi−f(A) [5]
Lo=σr−Med [6]

These operations yield Hi+Lo=f(A)+σr exactly, and Hi serves as the high part of the overall result, while Lo may be added into the polynomial and other parts. Although the above summation takes several floating-point operations, its latency is typically much lower than that of the full polynomial, and therefore has minimal impact on the overall latency.

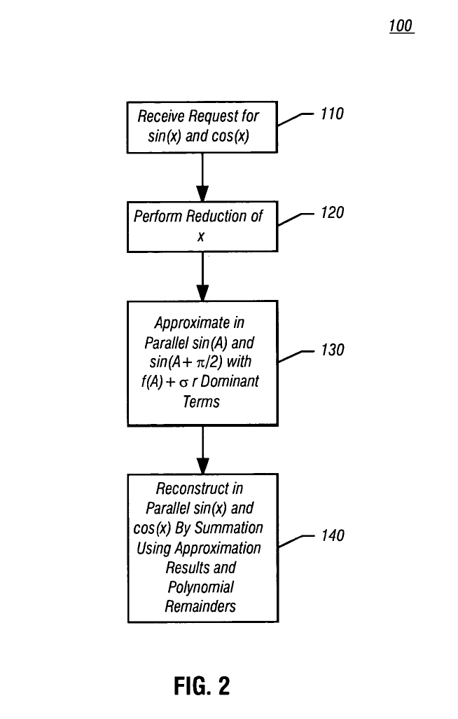

In one particular embodiment, the general approach described above may be ideally suited to a combined implementation of sin and cos. In such an embodiment, the two “sides” of the algorithm may be identical except for a single constant, except for the very rare special case of an exceptionally small or large input. Referring now to FIG. 2, shown is a flow diagram of a method of determining sin(x) and cos(x) in accordance with an embodiment of the present invention. As shown in FIG. 2, method 100 may begin by receiving a request for sin(x) and cos(x) (block 110). For example, in certain embodiments an uncompiled program may include a function call to perform a calculation of sin(x) or cos(x). During compilation, the compiler may cause the function call to be replaced with a function call for the combined sincos operation discussed herein, as it is likely that the program will include a function call for cos(x) in code near the function call for sin(x).

Still referring to FIG. 2, next a reduction of x may be performed, for example, r=x−A (block 120). Then in parallel, sin(A) and sin(A+π/2) may both be approximated according to a polynomial approximation such that f(A)+σr are the two dominant terms of the approximation (block 130). Finally, sin(x) and cos(x) may be reconstructed in parallel by a summation using the approximation results and polynomial remainders. In such manner, sin(x) and cos(x) may be obtained in virtually the same amount of time required to obtain either sin(x) or cos(x) (block 140). Furthermore, such results may be obtained in a branch-free manner, taking advantage of instruction level parallelism using SIMD instructions.

Thus according to the flow diagram of method 100, an initial range reduction from x to r may be performed as follows:

$$x \approx N \frac{π}{32} + r \qquad [ 7 ]$$

so that

$$\vert r \vert ≦ \frac{π}{64} + ε ,$$

where ε is the machine's unit round off, e.g., 2⁻²⁴ for single precision or 2⁻⁵³ for double precision. In this particular embodiment, inputs may be restricted to those where |N|≦932560, as beyond this, the range reduction may be insufficiently accurate. Thus, if the input exceeds this value, an alternative algorithm with a more accurate range reduction may be used. However, it is to be understood that such values are not expected to occur often in typical applications.

Further, in this particular embodiment, inputs where the smallest intermediate result created, approximately x⁴/7!, may underflow in double precision, may also and accordingly may also cause a branch to special code for |x|≦2⁻²⁵². Both very small and very large argument eventualities may be tested by looking at the exponent and top few significand bits of the input. Thus the main path may be taken for 2⁻²⁵²≦|x|<90112, which may be virtually all such inputs.

Aborting and using an alternative algorithm on exceptional inputs is, however, the only branch needed. The following algorithm in accordance with this particular embodiment is branch-free and may compute both sin and cos as needed. While discussed herein the algorithm is presented for sin, one may obtain cos by adding 16 to N

$$( i . e . , \frac{π}{2} to x ) .$$

To avoid branches, a range reduction may be performed to full accuracy each time:
r=x−N(P₁+P₂+P₃) [8]
where P₁ and P₂ are 32-bit numbers (so multiplication by N is exact) and P₃ is a 53-bit number, each of which are machine numbers representing the value of π/32. Together, these approximate π well enough for all cases in the restricted range. In other implementations of this particular embodiment, performing two steps:
r=x−N(P₁+P₂) [9]
gives a sufficiently good r for the polynomial calculation, and even the simple X−NP₁ may suffice for the topmost term. Hence the latency of part of the reduction may be hidden.

For the algorithm in accordance with this particular embodiment, the main reduction sequence is:

$$y = \frac{32}{π} x$$

N=integer (y)
m₁=NP₁
m₂=NP₂
r₁=x−m₁
r=r₁−m₂ (which may be used for most of the calculation)
c₁=r₁−r
m₃=NP₃
c₂=c₁−m₂
c=c₂m₃
   Rounding to an integer may be done using a “shifter” method, i.e., N=(y+s)−s, where s=2⁵²+2⁵¹.

Next, using the range reduced value, sin (B) may be approximated using a lookup table based on B=M {π/32}, where M=N mod 64 (note that for purposes of relating this discussion to the general embodiment above, B=A). In this particular embodiment, the stored values are: σ, which is the closest power of 2 to cos(B); Cₕₗ, which is the 53-bit value of cos(B)−σ; and Sₕᵢ and Sₗₒ, which are, respectively (53 and 24)-bit values of sin(B).

These stored values may be organized as 4*64 double-precision numbers. That is, each value may be calculated at 64 breakpoints (e.g., Nπ/64, where N=1 to 64). However, both Slo and σ may be represented as single-precision numbers, thus in certain embodiments the values may be stored as 3*64 double-precision numbers.

The polynomial of the core approximation may be organized as follows:

$$sin ( B + r + c ) = [ sin ( B ) + σr ] + r ( cos ( B ) - σ ) + sin ( B ) [ cos ( r + c ) - 1 ] + cos ( B ) [ sin ( r + c ) - r ] \qquad [ 10 ]$$

which is approximately:
[Sₕᵢ+σr]+Cₕₗr+Sₗₒ+Sₕᵢ[(cos(r)−1)−rc]+(Cₕₗ+σ)[sin(r)−r+c] [11]
This polynomial approximation may be what is actually computed. The sum may be separated into four parts: hi+med+pols+corr,
where:
hi=Sₕᵢ+σr
med=Cₕₗr [12]
pols=Sₕᵢ(cos(r)−1)+(Cₕᵢ+σ)(sin(r)−r) [13]
corr=Sₗₒ+c•((Cₕₗ+σ)−Sₕᵢ•r) [14]

It is to be noted that pols and corr are very small compared with the final result, while multiplication by σ is exact since it is a power of 2. Thus, assuming the summing of the components is done precisely, the only substantial error is in med, consisting of both the scaled approximation error in Cₕₗ and the rounding error in the multiplication. However, Cₕₗ•r is quite moderate as a proportion of the final result, as the error in this term never exceeds about 0.02 ulps in the final result.

However, rounding errors should be avoided in summing the components, since those may substantially affect the final error. In general, σr may be quite large relative to Sₕᵢ; for B={π\32} and r≈−π/64, σr≈B/2. Consequently, Sₕᵢ is not the dominant part of the result and the summation Sₕᵢ+σr must be done accurately.

In fact, the latency-critical part is the polynomial calculation, so while that is computed two successive compensated summations may be performed, namely the first addition of Sₕᵢ+σr and the next addition of the high part of this and Cₕₗr. In some embodiments, the latter is not needed, but may be appropriate since it significantly improves accuracy without significant effects on the overall latency. In fact, this extended precision and parallelism together improve performance of an approximation in certain embodiments, as the order of evaluation of a polynomial becomes unimportant. When a polynomial can be evaluated in an arbitrary order, parallelism may be fully utilized, and thus even long polynomials may be evaluated with a minimal latency.

As A becomes larger, it is no longer necessary to be so concerned that f′(A)−σ should be so close to a power of 2. In such an embodiment, σ=0 may be used. Alternatively, σ may be replaced by a full-length floating-point number when A is large and the rounding error in σr accepted.

In other embodiments, if r is known not to have the full number of significant bits, then rather than a 1-bit approximation of σ, more bits, e.g., 2 or 3, may be used without incurring a rounding error in the product σr. This situation may arise if r is calculated by a typical remainder operation. For example, if r=x−N d′ is set where

$$N = [ \frac{1}{d} \cdot x ]$$

and d′ is a short version of d designed to allow exact multiplication by N, then for an increasing N, there are fewer significant bits in r. Thus, the number of significant bits in σ may be increased as one moves further away from zero, which perfectly compensates for the fact that f′(A) is no longer so well approximated by a power of 2.

Embodiments may be implemented in code and may be stored on a storage medium having stored thereon instructions which can be used to program a computer system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), flash memories, electrically erasable programmable read-only memories (EEPROMs), magnetic or optical cards, or any type of media suitable for storing electronic instructions.

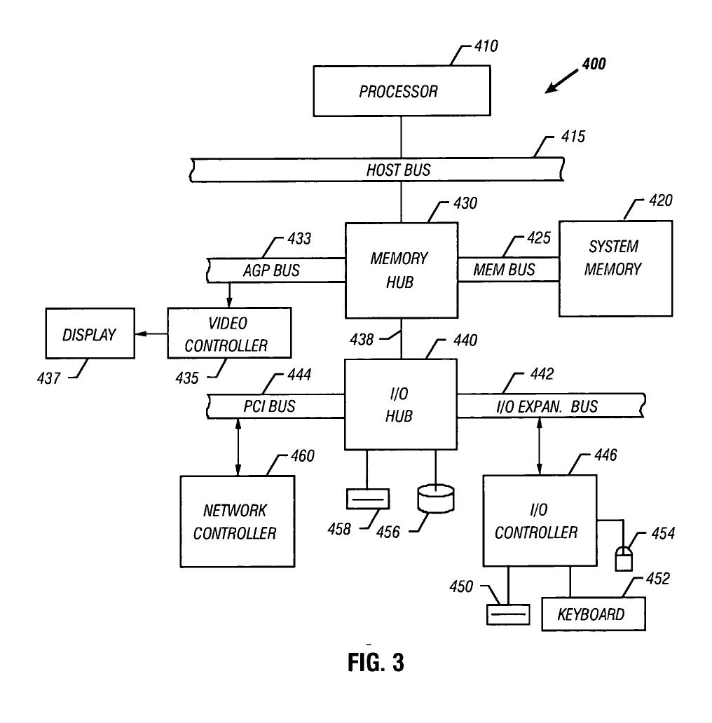

Example embodiments may be implemented in software for execution by a suitable computer system configured with a suitable combination of hardware devices. FIG. 3 is a block diagram of computer system 400 with which embodiments of the invention may be used.

Now referring to FIG. 3, in one embodiment, computer system 400 includes a processor 410, which may include a general-purpose or special-purpose processor such as a microprocessor, microcontroller, a programmable gate array (PGA), and the like. As used herein, the term “computer system” may refer to any type of processor-based system, such as a desktop computer, a server computer, a laptop computer, or the like.

The processor 410 may be coupled over a host bus 415 to a memory hub 430 in one embodiment, which may be coupled to a system memory 420 (e.g., a dynamic RAM) via a memory bus 425. The memory hub 430 may also be coupled over an Advanced Graphics Port (AGP) bus 433 to a video controller 435, which may be coupled to a display 437. The AGP bus 433 may conform to the Accelerated Graphics Port Interface Specification, Revision 2.0, published May 4, 1998, by Intel Corporation, Santa Clara, Calif.

The memory hub 430 may also be coupled (via a hub link 438) to an input/output (I/O) hub 440 that is coupled to a input/output (I/O) expansion bus 442 and a Peripheral Component Interconnect (PCI) bus 444, as defined by the PCI Local Bus Specification, Production Version, Revision 2.1 dated June 1995. The I/O expansion bus 442 may be coupled to an I/O controller 446 that controls access to one or more I/O devices. As shown in FIG. 3, these devices may include in one embodiment storage devices, such as a floppy disk drive 450 and input devices, such as keyboard 452 and mouse 454. The I/O hub 440 may also be coupled to, for example, a hard disk drive 456 and a compact disc (CD) drive 458, as shown in FIG. 3. It is to be understood that other storage media may also be included in the system.

The PCI bus 444 may also be coupled to various components including, for example, a network controller 460 that is coupled to a network port (not shown). Additional devices may be coupled to the I/O expansion bus 442 and the PCI bus 444, such as an input/output control circuit coupled to a parallel port, serial port, a non-volatile memory, and the like.

Although the description makes reference to specific components of the system 400, it is contemplated that numerous modifications and variations of the described and illustrated embodiments may be possible. More so, while FIG. 3 shows a block diagram of a system such as a personal computer, it is to be understood that embodiments of the present invention may be implemented in a wireless device such as a cellular phone, personal digital assistant (PDA) or the like.

In certain embodiments, the branch-free software methodology described above for computing a transcendental function may be written in assembly language for processor 410 of system 400. Such code may be part of a compiler program to translate higher level programs, written in a particular source code, into machine code for processor 410.

The compiler may include an operation in which the source code is parsed according to conventional techniques and a reference to a transcendental function is detected. The compiler may then replace all instances of this high level function call by a sequence of assembly language instructions that implement the appropriate branch-free methodology for that transcendental function. More so, in certain embodiments, the compiler may detect a call for a sin or cos operation and replace the call with the combined sincos algorithm discussed above. In other embodiments, the code may be part of a software library, such as a mathematical library of functions, that can be called using a desired programming language.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
reducing an input argument x of a function to a range reduced value r according to a first reduction sequence;
approximating a polynomial for a corresponding function of r having a dominant portion f(A)+σr; and
obtaining a first result for the function using the polynomial.

2. The method of claim 1, wherein the dominant portion comprises a first term f(A) and a second term σr, where A equals x minus r, and an absolute value of σ is a power of two.

3. The method of claim 1, wherein approximating the polynomial comprises performing a plurality of successive addition/subtraction operations.

4. The method of claim 1, wherein approximating the polynomial comprises using a lookup table to obtain a breakpoint for f(A).

5. The method of claim 1, further comprising restricting the input argument x to values within a predetermined window.

6. The method of claim 1, further comprising restricting the input argument x to values between 2⁻²⁵² and 90112.

7. The method of claim 1, wherein obtaining the first result for the function comprises obtaining sin(x).

8. The method of claim 7, further comprising obtaining a second result for the function using a second input y, wherein y is π/2 greater than x.

9. The method of claim 8, wherein obtaining the second result for the function comprises obtaining cos(x).

10. The method of claim 9, further comprising obtaining sin(x) and cos(x) using a single instruction multiple data (SIMD) floating-point operation.

11. The method of claim 9, further comprising obtaining the first result and the second result in parallel.

12. An article comprising a machine-accessible storage medium containing instructions that if executed enable a system to:
reduce an input argument x of a function to a range reduced value r according to a first reduction sequence;
approximate a polynomial for a corresponding function of r having a dominant portion f(A)+σr; and
obtain a first result for the function using the polynomial.

13. The article of claim 12, further comprising instructions that if executed enable the system to approximate the polynomial wherein the dominant portion comprises a first term f(A) and a second term σr, where A equals x minus r, and an absolute value of σ is a power of two.

14. The article of claim 12, further comprising instructions that if executed enable the system to approximate the polynomial using a lookup table to obtain a breakpoint for f(A).

15. The article of claim 12, further comprising instructions that if executed enable the system to obtain a second result for the function equal to cos(x), wherein the first result is equal to sin(x).

16. The article of claim 15, further comprising instructions that if executed enable the system to obtain sin(x) and cos(x) using a single instruction multiple data (SIMD) floating-point operation.

17. The article of claim 15, further comprising instructions that if executed enable the system to obtain the first result and the second result in parallel.

18. A system comprising:
a processor; and
a dynamic random access memory coupled to the processor including instructions that if executed enable the system to reduce an input argument x of a function to a range reduced value r according to a first reduction sequence, approximate a polynomial for a corresponding function of r having a dominant portion f(A)+σr, and obtain a first result for the function using the polynomial.

19. The system of claim 18, wherein the dynamic random access memory further includes instructions that if executed enable the system to obtain a second result for the function equal to cos(x), wherein the first result is equal to sin(x).

20. The system of claim 19, wherein the dynamic random access memory further includes instructions that if executed enable the system to obtain sin(x) and cos(x) using a single instruction multiple data (SIMD) floating-point operation.

21. The system of claim 20, wherein the dynamic random access memory further includes instructions that if executed enable the system to obtain sin(x) and cos(x) using a single instruction multiple data (SIMD) floating-point operation when a function call requests either of sin(x) or cos(x).

22. The system of claim 20, wherein the dynamic random access memory further includes instructions that if executed enable the system to obtain the first result and the second result in parallel.
